(19) United States
(12) Patent Application Publication
(10) Pub. No.: US 2012/0280507 A1
(43) Pub. Date: Nov. 8, 2012

(54) BIDIRECTIONAL TURBINE BLADE

(75) Inventors: John Keir, Singapore (SG); Sutthiphong Srigrarom, Singapore (SG)

(73) Assignee: ATLANTIS RESOURCES CORPORATION PTE LIMITED, Singapore (SG)

(21) Appl. No.: 13/266,670

(22) PCT Filed: Apr. 28, 2010
(86) PCT No.: PCT/IB10/01364

§ 371 Date: Apr. 16, 2012

(30) Foreign Application Priority Data
Apr. 28, 2009 (AU) 2009901851

(51) Int. Cl. F04D 29/38; B21D 53/78; F03B 13/00

(52) U.S. Cl. 290/54; 416/223 R; 29/889

(57) ABSTRACT

A bidirectional turbine blade including: a blade root and blade tip; a first face and a second face running between the blade root and blade tip; a cross-sectional profile which is symmetrical about a chord line extending between longitudinal edges of the blade; and a twist of between about 5 and 35 degrees from the chord line, wherein the blade is capable of driving an underwater turbine from flowing water incident at the first face or the second face.

### TECHNICAL FIELD

The present invention relates generally to underwater turbines and blades for those turbines. Certain embodiments of the present invention relate to a design of blade which is suitable for use in underwater turbines which are adapted to receive flow from a forward direction and a reverse direction without moving the turbine relative to the flow.

### BACKGROUND ART

Although flows of water are generally predictable, they often undergo minor and major changes in direction. Minor changes in direction may involve a shift of a few degrees from a particular flow direction. Major changes in direction involve a shift of 180 degrees every six hours, such as in tidal flow reversals.

When designing underwater power generation units, these major changes in flow direction have generally been accommodated by turning structures and mechanisms so that the units can reverse their attitude to receive the reversed flow of water. However, these turning structures and mechanisms are expensive to construct, install and maintain.

The present invention seeks to ameliorate one or more of the abovementioned disadvantages.

### DISCLOSURE OF INVENTION

According to a first aspect of the present invention there is provided a bidirectional turbine blade including:

a blade root and blade tip;

a first face and a second face running between the blade root and blade tip;

a cross-sectional profile which is symmetrical about a chord line extending between longitudinal edges of the blade; and

a twist of between about 5 and 35 degrees from the chord line, wherein the blade is capable of driving an underwater turbine from water flowing at the first face or the second face.

The blade is particularly suitable for use with a central axis underwater power generation turbine.

The blade may be any suitable symmetrical cross-sectional profile, including flat, double wedge and hexagonal (modified double wedge). In preferred embodiments, to facilitate increased lift and reduced drag, the cross-sectional profile is BiConvex, which is an elliptical profile shape.

Preferably the twist is about a central longitudinal axis of the blade, or at a midpoint of the chord line along the blade length, so that the overall twisted blade shape is symmetrical. Preferably the twist is about a selected longitudinal axis of the blade or at a midpoint of the chord line along the blade length, so that in the latter case the overall twisted blade shape is symmetrical.

Preferably the overall twist is in a range of about 10 to 20 degrees. In one preferred embodiment the twist is about 14 degrees from blade root to tip. Testing and modeling by the inventors indicates twist ranges between about 5 and 35 degrees being efficient and useful with other preferred features of the invention.

Preferably the blade faces are tapered so that the longitudinal edges are raked inwards toward the central longitudinal axis. In preferred embodiments the taper is such that a length of the chord at the blade tip is approximately 10% shorter than the length of the chord at the blade root. Testing and modeling by the inventors indicates that a range of tapers may be useful and efficient in this blade design, say, between about 2 and 30%.

When installed in a turbine, the blade is disposed such that an intermediate portion of the blade is angled to the central axis of the turbine at approximately 45 degrees. This means that when installed, the preferred blade twists toward the incoming water flow by several degrees in a root or proximal blade region and away from the flow or rearward or downstream by several degrees in a tip or distal blade region.

According to a second aspect of the present invention there is provided use of a bidirectional turbine blade according to the first aspect of the present invention in an underwater turbine.

According to a third aspect of the present invention there is provided use of a bidirectional turbine blade according to the first aspect of the present invention to generate power for water flowing to an underwater turbine.

Preferably, the underwater turbine is a central axis water turbine which includes:
a turbine body having a central axis;
a rotor mounted on the turbine body for rotation about the central axis, the rotor comprising a central hub supporting a plurality of blades, each blade extending from the blade root mounted on the hub to the blade tip;
a generator driven by the rotor; and
a housing surrounding the rotor and adapted to direct water flow towards the blades.

The blades may be splayed or raked rearwardly by an angle of between 1 and 20 degrees, which may improve efficiency. Preferably the blades are splayed rearward from the blade root to the blade tip by a tilt angle of 2° to 10°, and more preferably by 4° to 6° from the plane perpendicular to the central axis. Further preferably, the blades are splayed rearward from the blade root to the blade tip by a tilt angle of about 5° from the plane perpendicular to the central axis.

The rotor preferably includes a nose cone mounted on the front of the rotor to reduce drag on the rotor and reduce turbulent water flow through the housing. Preferably the nose cone is hollow to provide space for auxiliary systems such as control system or reservoirs for auxiliary or even primary systems.

In a preferred embodiment, the generator is housed with the rotor, the generator being adapted to generate electrical power from the rotation of the rotor. Preferably the generator is directly connected to a shaft. Preferably the generator is connected to the shaft by a splined connection.

Preferably, the generator is driven directly by the rotor, and this arrangement may suit the input speed required by selected generators such as multi-pole or high-pole electric generators. However, in some arrangements it may be suitable to connect a gearbox to the shaft or generator so that the rotation speed of shaft input to the generator is converted to a rotation speed that suits other types of generator.

Preferably support struts are provided to support the rotor and generator. Preferably the support struts are hollow to provide ducts or reservoirs. In one arrangement the support struts extend substantially radially between the rotor and generator. In preferred embodiments, a generator end of the support strut is mounted so that the support strut extends substantially tangentially to the generator. This is to improve torque transfer between the generator and the housing, facilitating lighter support struts. Furthermore, an advantage of this preferred arrangement is that fatigue loads on the support struts are reduced since the tangentially-mounted support struts are never disposed completely behind, or completely “shadowed” by the radially-mounted blades when in use.

Preferably a brake is provided, in use to inhibit rotation of the rotor. Preferably the brake is a fail-safe mechanism. Preferably in use a braking actuator holds a brake element remote from the rotor against an actuation force when power is applied to the brake element. In use, when power is removed from the braking actuator, the actuation, force, which may be from a spring or utilising some appropriate other kind of urging force, overcomes the braking actuator's force and applies the braking element to the rotor, slowing or stopping the rotation of the rotor.

Preferably a boot or a plug is provided at the blade root to cover any gaps or bumps or bolt heads and the like to minimise interference drag in that region.

Preferably, the housing converges from a front opening forward of the rotor to a narrower throat adjacent the turbine body. Preferably, the housing defines a flow channel having a flow restriction. Advantageously, this arrangement increases the velocity of liquid flowing through the flow channel in a restricted part of the flow channel, relative to an unrestricted part of the flow channel. The flow restriction preferably comprises a venturi, which may form part or the entire flow channel. In particular, the venturi may comprise a divergent-convergent-divergent venturi, tapering from openings at either end of the flow channel towards an inner part of the flow channel. Preferably the housing is in the form of a main body comprising a cylindrical bore within which the rotor and blades are disposed.

Preferably the housing is substantially symmetrical about the rotor.

In a preferred embodiment, the housing extends rearward of the rotor and acts as a diffuser, the housing diverging from the throat to a rear opening rearward of the rotor.

Preferably, the rotor supports at least two blades. Further preferably, the turbine has either 3 or 6 blades. It will be appreciated, however, that any number of blades of 2, 3, 4, 5, 6 or more can be used with the turbine.

Preferred embodiments of the present invention include raked or rearwardly—splayed blades, from the base to the blade tip by a tilt angle of about 1° to 20° from a plane perpendicular to the central axis to facilitate improved usable power generation from the turbine.

According to another aspect of the present invention there is provided a method of generating power from water flow, the method comprising:
providing a central axis water turbine to a marine or river environment;
the central axis water turbine including a turbine body having a central axis;
a rotor mounted on the turbine body for rotation about the central axis, the rotor comprising a central hub supporting a plurality of blades, each blade extending from the blade root mounted on the hub to the blade tip;
a generator driven by the rotor; and
a housing surrounding the rotor and adapted to direct water flow towards the blades, wherein the blades are splayed or raked rearwardly by an angle of between 1 and 20 degrees,
allowing water movement through the turbine to cause the blades to rotate; and
drawing usable power from the turbine.

According to yet another aspect of the present invention there is provided a kit of parts for a central axis water turbine, the kit including: a power generator module comprising a central axis and a turbine body, a rotor mounted on the turbine body for rotation about the central axis, the rotor comprising a central hub for supporting a plurality of blades, the power generator module further including mounts for mounting one or more support struts and a generator in use driven by the rotor; a plurality of blades; a housing; a plurality of support struts for supporting the power generator module in a central position relative to the housing; wherein the housing, when in use surrounds the rotor and includes one or more inner walls being spaced from the rotor so as to be disposed adjacent the plurality of blade tips at least at selected times when in use, wherein the housing further includes support strut mounts for mounting support struts so that to install on site, the support struts may be readily assembled to extend between the power generator module and the housing.

Turbines according to preferred embodiments of the present invention are suitable for use in flowing bodies of water such as found in the sea and in rivers. Sea currents and tidal flows can be harnessed by the present invention to generate electricity.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia before the priority date of each claim of this specification.

### BRIEF DESCRIPTION OF THE DRAWINGS

In order to enable a clearer understanding of the invention, preferred embodiments will hereinafter be described while referring to the Figures, and in those Figures:

FIG. 1 is an isometric view of a bidirectional turbine blade in accordance with a preferred embodiment of the present invention;

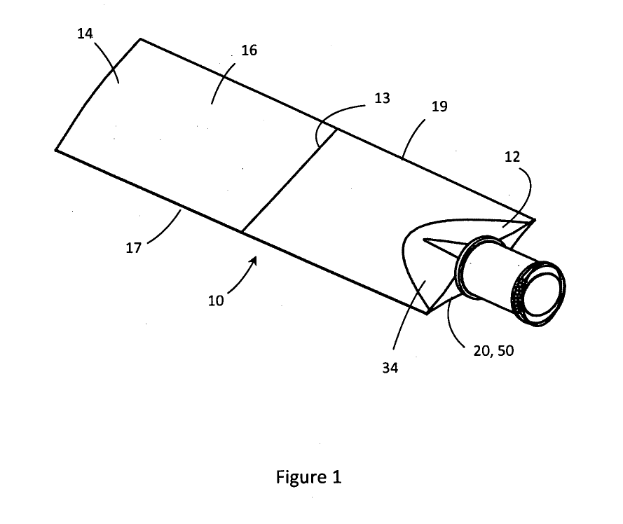

FIG. 2 is a front elevation view of the bidirectional blade of FIG. 1, showing the blade root projected in line with the plane of the page;

FIG. 3 shows a plurality of section views cut across the blade of FIG. 1 at various points therealong;

FIG. 4 is a front elevation view of the bidirectional blade of FIG. 1 showing the blade tip projected in line with the plane of the page;

FIG. 5 is a section view of the bidirectional blade of FIG. 1, the section being a longitudinal section and viewed along a central camber line;

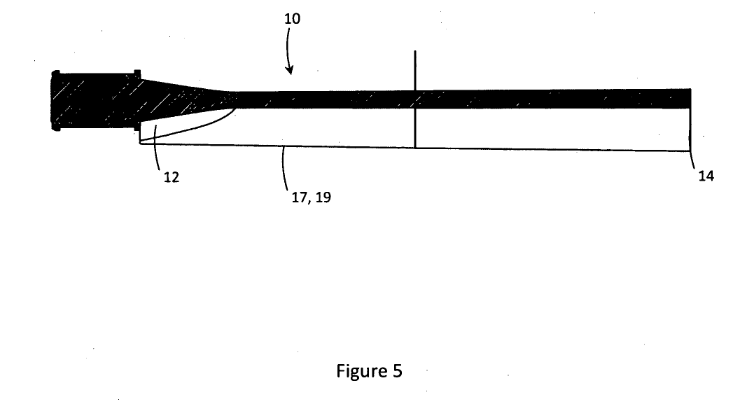

FIG. 6 is a view from the blade tip, essentially being a plan view, of the blade of FIG. 1;

FIG. 7 is a view from the blade root, essentially being a plan view from below, of the blade of FIG. 1;

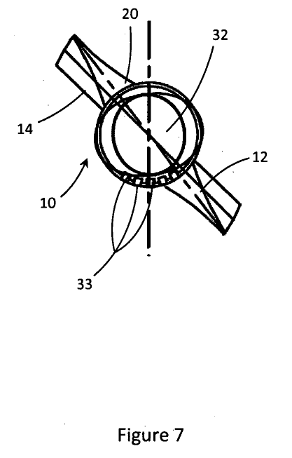

FIG. 8 is a graph showing modelling and testing results relating to efficiency compared with various twist angles of preferred embodiments of the present blade;

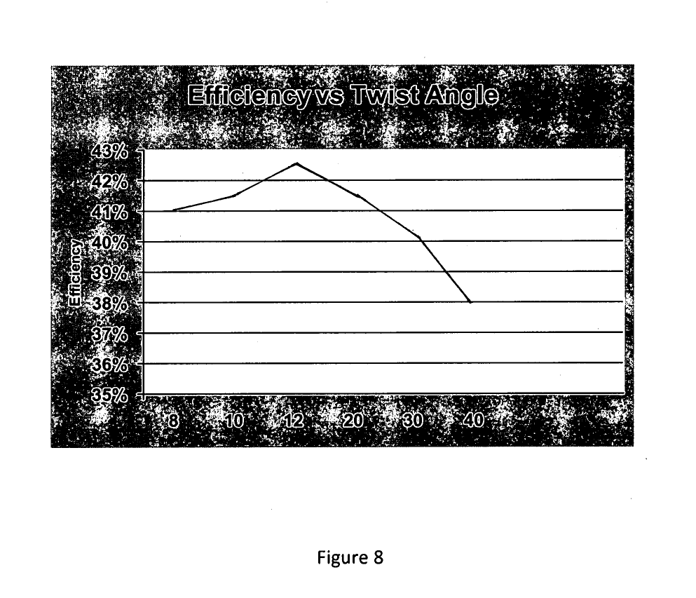

FIG. 9 is a graph showing modelling and testing results relating to efficiency compared with various attack angles of preferred embodiments of the present blade;

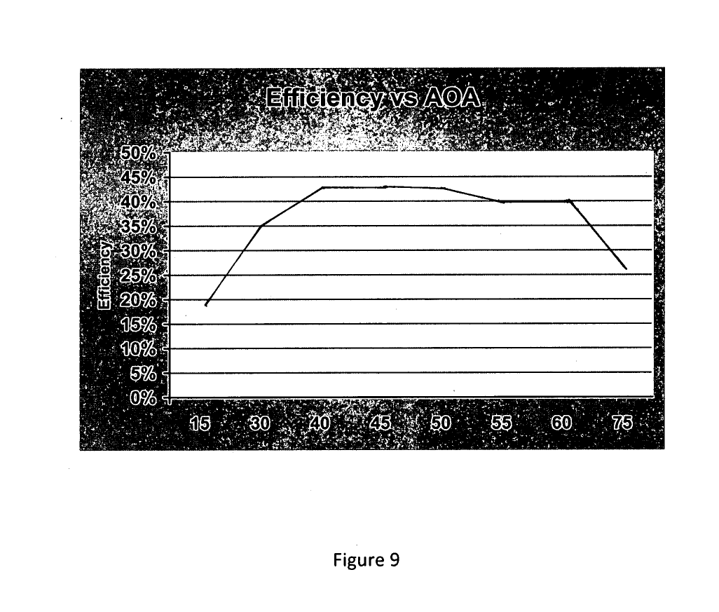

FIG. 10 is an isometric view of a turbine having bidirectional blades; and

FIG. 11 is a front elevation view of the turbine of FIG. 10.

### DETAILED DESCRIPTION OF THE PREFERRED EMBODIMENTS

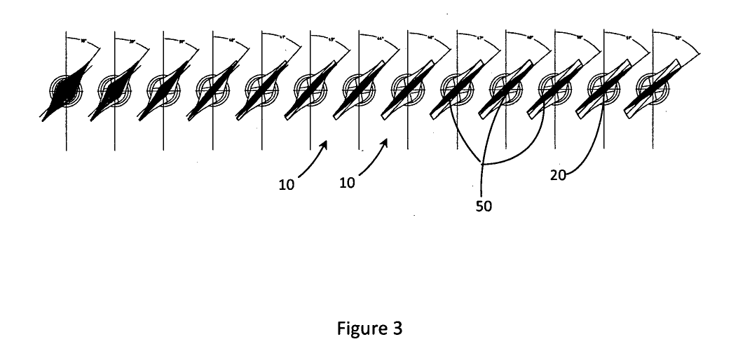

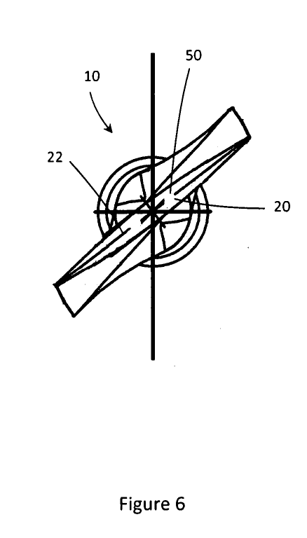

Referring to the Figures there is shown a blade generally indicated at 10, the blade 10 being suitable for use with a central axis marine turbine (not shown), the blade 10 including a blade root 12 and a blade tip 14, a first face 16 and a second face 18, the faces 16 and 18 extending between the blade root 12 and the blade tip 14 and bounded longitudinally by longitudinal (or leading/trailing) edges 17 and 19. The blade 10 further includes a cross-sectional profile 20 which is symmetrical about a chord line 22, the latter of which extends between edges 17 and 19. The blade profile is shown at FIGS. 3 and 6, is biconvex, and indicated at 50.

The blade 10 includes a twist which in some arrangements may be effective when in a range of about 5° and 35° but in the preferred embodiment shown, for increased efficiency, is about 14° from root to tip.

The faces 16 and 18 may be any suitable projected shape, however, in the embodiment shown in the Figures, the faces 16 and 18 are tapered from bade root 12 to blade tip 14. The chord line 22 at the blade tip 14 is shorter than the chord line 22 at the blade root 12, and in the preferred embodiments the amount of shortening is approximately 10%.

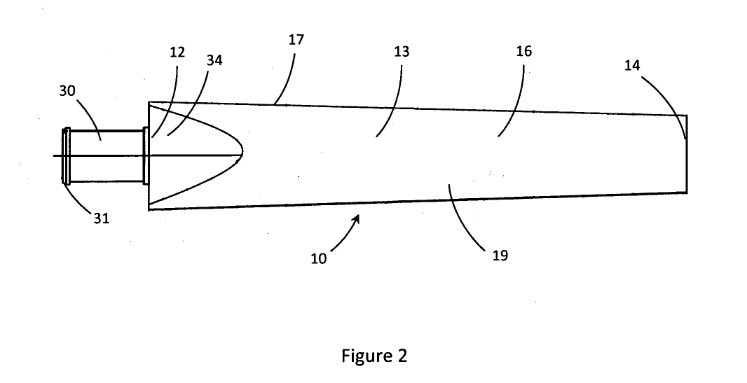

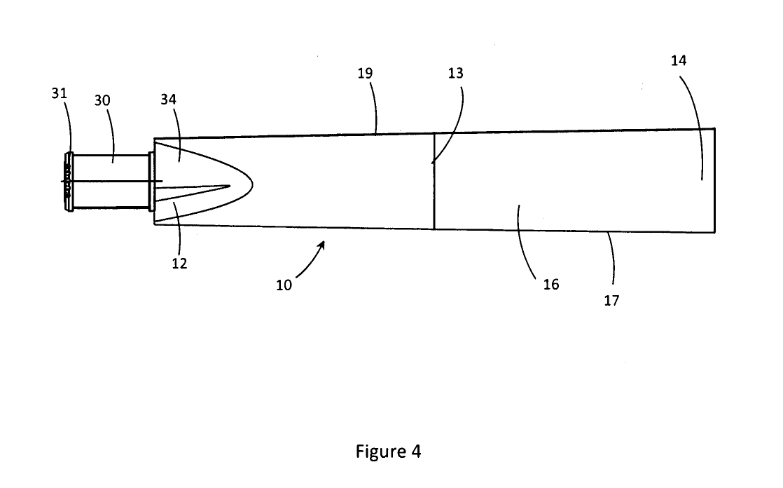

Twist of the blade 10 is clearly indicated in FIGS. 2 and 4. FIG. 2 is a front elevation view of a preferred blade 10, but the blade is oriented so that the plane of the blade root 12 is parallel with the plane of the page. The blade tip 14 can be seen to be rotated from the plane of the page, and it appears to be strongly tapered. However, although the blade faces are tapered towards the blade tip end 14, the FIG. 2 looks tapered because of the twist. FIG. 4 is shown to show the blade tip end 14 projected parallel with the plane of the page.

When installed in a central axis turbine (not shown), the blade 10 is disposed such that an intermediate portion 13 of the blade is angled to the central axis of the turbine at 45°. This arrangement is such that the blade 10 twists forward by several degrees from the intermediate portion 13 to the blade root 12, and twists backwards from the intermediate portion 13 by several degrees towards the blade tip 14. FIG. 3 shows the development of the twist as various sections are taken along the blade 10.

The blade is constructed from composite materials such as carbon-fibre reinforced polymers though in some arrangements the blades may be cast from polymers, metals, alloys, and the like.

In order to facilitate installation of the blade into a hub of a rotor on the central axis turbine, a sleeve 30 is affixed by interference fit or adhesive to a blade stub 32. The sleeve includes a plurality of recesses 33 which receive a pin (not shown) which extends from a corresponding hole in the hub, and in this way the blade angle of attack may be altered. The sleeve 30 includes flanges 31 which in use abut an inner wall of the hub so that the blade is inhibited from removal under the radial forces developed while rotating. Stress reducing regions 34 are included in the blade in the form of a wedge of material at the blade root. This is an area in the blade of high stress, so the stress reducing wedge can be useful.

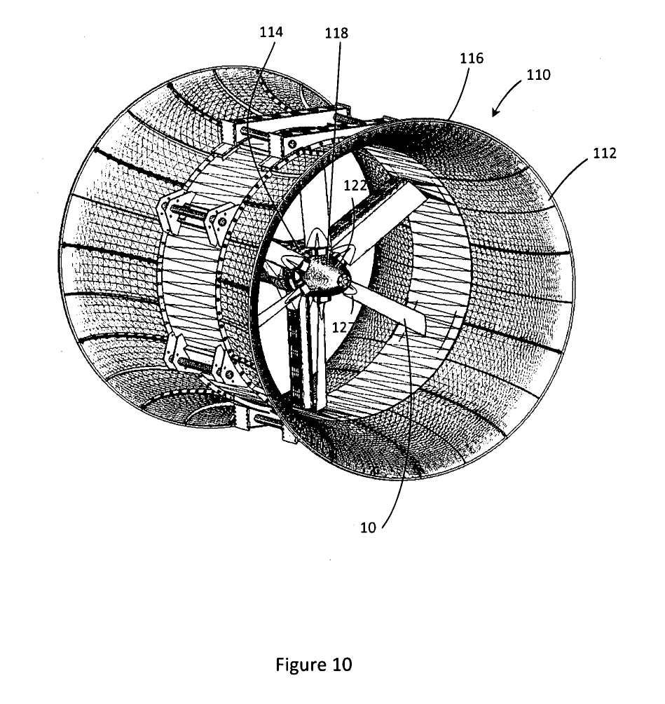

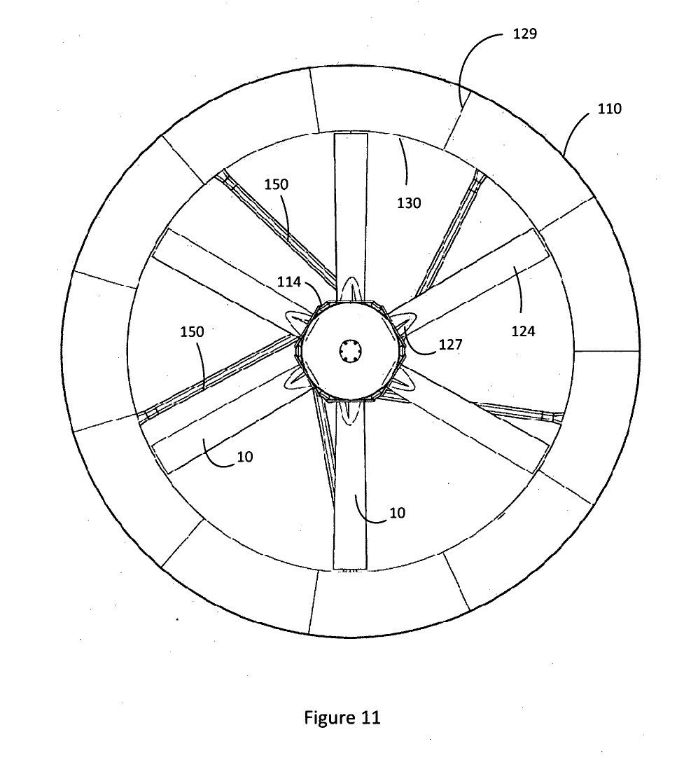

The kind of turbines in which this blade may be suitably deployed include horizontal-axis turbines, such as those shown in FIGS. 10 and 11, but note that the central-axis turbines may or may not include housings 116. Referring to those Figures, a central axis water turbine assembly in accordance with a preferred embodiment of the present invention is generally indicated at 110 and comprises a main body 112, a rotor 114 and an optional housing or cowling 116. The main body 112 includes an electric generator assembly 118 and the rotor 114 is mounted for rotation on a shaft 120 about a central axis. The rotor 114 includes a hub 122 supporting a plurality of blades 124, the present preferred embodiment shown with six blades, each blade extending from a blade root 127 mounted on the hub to a blade tip 128. When installed, the housing 116 is disposed in a position so that an inner wall encircles the rotor 114 and in some embodiments converges from a front opening 129 forward of the rotor to a narrower throat 130 adjacent the rotor 114 to direct water flow towards the blades 124. Support struts 150 are mounted tangentially to the generator unit 118 so as to be more efficient at taking the torque loads of the generator and rotor.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A bidirectional turbine blade including:
a blade root and blade tip;
a first face and a second face running between the blade root and blade tip;
a cross-sectional profile which is symmetrical about a chord line extending between longitudinal edges of the blade; and
a twist of between about 5 and 35 degrees from the chord line, wherein the blade is capable of driving an underwater turbine from flowing water incident at the first face or the second face.

2. The turbine blade according to claim 1 wherein the twist is in a range of about 10 to 20 degrees

3. The turbine blade according to claim 1 wherein the twist is about 14 degrees from blade root to tip.

4. The turbine blade according to claim 1 wherein the blade is a symmetrical cross-sectional profile.

5. The turbine blade according to claim 1 wherein the cross-sectional profile is in the form of a substantially flat section and/or at various points across the section, double wedge and/or hexagonal.

6. The turbine blade according to claim 4 wherein the cross-sectional profile is biconvex, which is an elliptical profile shape.

7. The turbine blade according to claim 1 wherein the twist is about a selected longitudinal axis of the blade or at a midpoint of the chord line along the blade length, so that in the latter case the overall twisted blade shape is symmetrical.

8. The turbine blade according to claim 1 wherein the blade faces are tapered so that the longitudinal edges are raked inwards toward the central longitudinal axis.

9. The turbine blade according to claim 8 wherein the taper is such that a length of the chord at the blade tip is between approximately 2% and 70% shorter than the length of the chord at the blade root.

10. The turbine blade according to claim 9 wherein the taper is approximately 10% at the blade tip.

11. The turbine blade according to claim 1 wherein, when installed in a turbine, the blade is disposed such that an intermediate portion of the blade is angled to the central axis of the turbine at approximately 45 degrees so that when installed, some of the blade twist is upstream of the 45 degree disposition, so as to be generally thought of as being twisted toward the incoming water flow by several degrees in a root or proximal blade region and, in a tip or distal blade region, feathered away from the flow or rearward or downstream by several degrees.

12. A method of powering an underwater power generating turbine, the method including the step of installing one or more bidirectional turbine blades according to claim 1 on or in an underwater turbine.

13. A method of generating power, the method including the step installing an underwater power generator which comprises one or more bidirectional turbine blades in accordance with claim 1.

14. A central axis underwater power generating turbine including:
a turbine body comprising a central axis;
a generator operatively associated with the turbine body for generating power;
one or more blades operatively associated with the turbine body for rotation about the central axis, each blade being in accordance with claim 1.

15. The central axis underwater turbine according to claim 14 which includes a housing surrounding the turbine body and adapted to direct water flow towards the blades.
